(19) United States
(12) Patent Application Publication
(10) Pub. No.: US 2026/0288421 A1
(43) Pub. Date: Sep. 24, 2026

(54) AUTOMATIC SOFTWARE CODE AND SUPPLEMENTAL PRODUCT GENERATION FROM BEHAVIOR-DRIVEN DESIGN SCENARIOS AND RELATED COMPUTING SYSTEMS AND METHODS

(71) Applicant: CDK Global, LLC, Austin, TX (US)

(72) Inventors: Marc Von Ahn, West Linn, OR (US); Harshit Doshi, Dublin, CA (US)

(21) Appl. No.: 19/084,454

(22) Filed: Mar. 19, 2025

(51) Int. Cl. G06F 8/30; G06F 8/73

(52) U.S. Cl. CPC G06F 8/30; G06F 8/73

(57) ABSTRACT

Automatically generating software code and supplemental products and related computing systems and methods are disclosed. A computing system includes one or more processors and one or more data storage devices including computer-readable instructions stored thereon. The computer-readable instructions are configured to instruct the one or more processors to receive, as input, behavior-driven design (BDD) scenarios corresponding to one or more functions of a software program, automatically generate software code for the software program responsive to the BDD scenarios, and automatically generate one or more of user documentation, test scenarios, or a chatbot for the software program responsive to the BDD scenarios. A method includes receiving BDD scenarios corresponding to functions of a software program, automatically generating software code for the software program responsive to the BDD scenarios, and automatically generating one or more of user documentation, test scenarios, or a chatbot for the software program responsive to the BDD scenarios.

### TECHNICAL FIELD

This disclosure relates generally to computing systems and related methods for generating software code and supplemental products (e.g., user documentation, test scenarios, a chatbot) responsive to behavior-driven design (BDD) scenarios.

### BACKGROUND

Modern software programs may evolve over time due to added features, updates, and other changes. Supplemental products may assist users in understanding how to use these software programs. In some instances, keeping these supplemental products up to date with the changes in these software programs may be challenging or impossible.

### BRIEF SUMMARY

In some embodiments, a computing system includes one or more processors and one or more data storage devices. The one or more data storage devices include computer-readable instructions stored thereon. The computer-readable instructions are configured to instruct the one or more processors to receive, as input, one or more BDD scenarios corresponding to one or more functions of a software program. The computer-readable instructions are also configured to instruct the one or more processors to automatically generate software code for the software program responsive to the one or more BDD scenarios. The computer-readable instructions are further configured to automatically generate one or more of user documentation, test scenarios, or a chatbot for the software program responsive to the one or more BDD scenarios.

In some embodiments, a method of automatically generating software code and supplemental products includes receiving one or more BDD scenarios corresponding to one or more functions of a software program. The method also includes automatically generating software code for the software program responsive to the one or more BDD scenarios. The method further includes automatically generating one or more of user documentation, test scenarios, or a chatbot responsive to the one or more BDD scenarios.

In some embodiments, a computing system includes one or more processors and one or more data storage devices operably coupled to the one or more processors. The one or more data storage devices include, stored thereon, existing code for a software program; existing user documentation data corresponding to existing user documentation for the software program; existing functional test data corresponding to existing functional tests for the software program; chatbot code for a chatbot corresponding to the software program; and computer-readable instructions. The computer-readable instructions are configured to instruct the one or more processors to automatically generate updated software code for the software program responsive to one or more BDD scenarios and automatically generate one or more of new user documentation data, new functional test data, or new chatbot code responsive to the one or more BDD scenarios.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flowchart illustrating a method of generating approved BDD scenarios, according to some embodiments;

FIG. 2 is a flowchart illustrating a method of automatically generating a software code, according to some embodiments;

FIG. 3 is a flowchart illustrating a method of automatically generating user documentation, according to some embodiments;

FIG. 4 is a flowchart illustrating a method of automatically generating functional test scenarios, according to some embodiments;

FIG. 5 is a flowchart illustrating a method of automatically generating a chatbot, according to some embodiments;

FIG. 6 is a block diagram of a computing system, according to some embodiments;

FIG. 7 is a flowchart illustrating a method of automatically generating software code and supplemental products, according to some embodiments; and

FIG. 8 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms "exemplary," "by example," and "for example," means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general-purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general‑purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as "first," "second," and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term "substantially" in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

In developing features for software, it may be helpful to generate supplemental products such as user documentation, test scenarios and procedures, and/or a chatbot companion for the software. These supplemental products may enable users, test technicians, and others to use, learn, test, and/or interact with the software. In some instances, however, modifications may be made to software features after creation of these supplemental products, and as a result, these supplemental products may not accurately reflect all the features of the software. Also, in some instances, theses supplemental products may not accurately reflect all the features of the software for other reasons such as being created based on inaccurate assumptions of the software features.

Embodiments disclosed herein include computing systems and related methods for generating software code and supplemental products (e.g., user documentation, test scenarios, a chatbot) responsive to BDD scenarios. BDD scenarios may be detailed, written descriptions of how a software product should function. BDD scenarios identify actions that a user can take while operating the software product and outcomes that should occur in response to those actions. BDD scenarios may be detailed enough to describe at least substantially all the functioning of a software product. If provided in this complete level of detail, BDD scenarios may be used in conjunction with artificial intelligence (AI) software code generation tools to generate software code for the complete software product. In some embodiments, BDD scenarios may be created by humans. By way of non-limiting example, the BDD scenarios may be created manually as a collaboration between software development personnel, product development personnel, test personnel, and/or other personnel. In some embodiments, at least a portion of the creation of BDD scenarios may be automated or assisted by software.

Generation of the software code and supplemental products using the same BDD scenarios assures that the supplemental products match the software code. By way of non-limiting example, the BDD scenarios may be used by AI software code generating tools to automatically generate software code for a software program. Other AI tools may be used to generate user documentation, test scenarios, and/or a chatbot based on the same BDD scenarios used to generate the software code. As a result, the software program functionality covered by the user documentation, test scenarios, and chatbot would match the software program functionality of the software program. Furthermore, updates to the software program may be made by providing updated BDD scenarios to the AI software code generating tools and the AI tools that generate the user documentation, the test scenarios, and/or the chatbot. As a result, updates to the software program may be accompanied by corresponding updates to the user documentation, the test scenarios, and/or the chatbot to keep all these supplemental products up to date with the software program in at least substantially real-time. This manner of updating and adapting a software product and generating supplemental products may be automated to keep the supplemental products as up to date as the software product. As a result, generation of software code and the supplemental products may be driven by merely providing complete and accurate BDD scenarios.

BDD scenarios may be created during a product or feature development phase. These BDD scenarios may comprehensively define the behavior of the product or feature being developed. These BDD scenarios may be used to create functional tests (e.g., test scenarios) to confirm the produced engineering product (e.g., a software program) meets the expectations of a customer. The BDD scenarios may also be used, through a transformation process, to create and maintain user documentation (e.g., online user documentation) based on the BDD scenarios, which have been tested using the functional tests. Furthermore, the BDD scenarios may be used to create a chatbot that may be used by end users to query how to perform a function using the produced engineering product. The chatbot accuracy may be assured because the same BDD scenarios used to generate the software program, the test scenarios, and the user documentation are used to generate the chatbot. Automated creation of base code to deliver defined features may be used in conjunction with automated maintenance of the user documentation, the test scenarios, and the chatbot through the build and development process to ensure that all deployed functionality is documented, searchable, and testable.

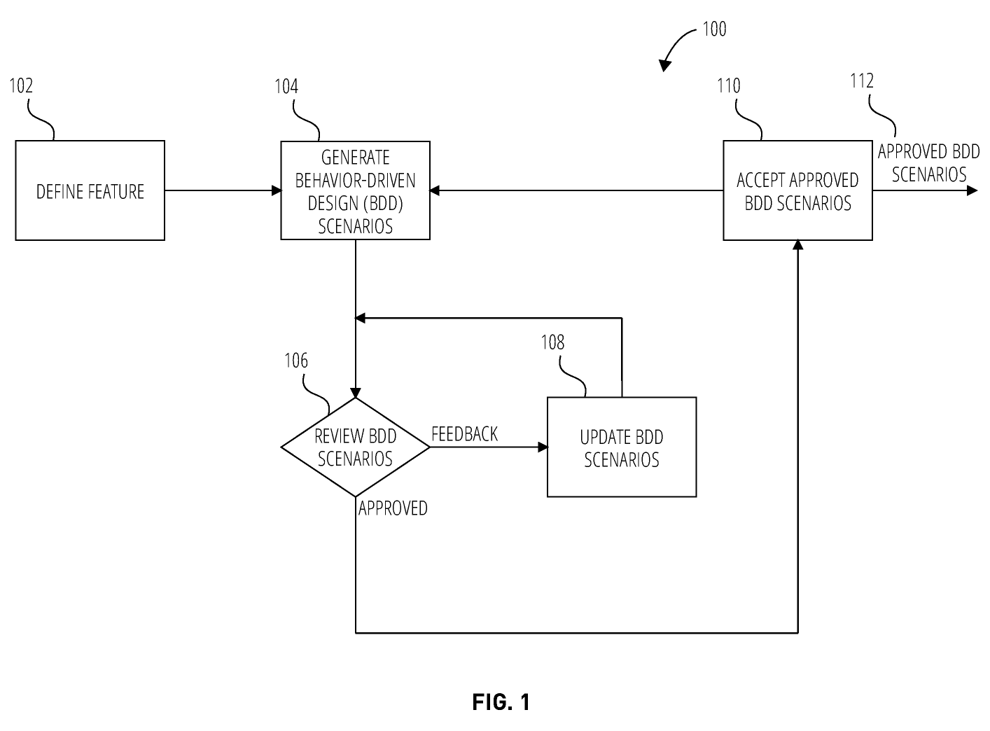

FIG. 1 is a flowchart illustrating a method 100 of generating approved BDD scenarios 112, according to some embodiments. These approved BDD scenarios 112 may be used to automatically generate software code for a software program and supplemental products (e.g., user documentation, test scenarios, a chatbot, etc.). At operation 102, the method 100 includes defining a feature to be included by a software program. The feature may be a function that it is desired that the software program perform. By way of non-limiting example, features to be included in a software program may include data input/output, data and/or signal processing, transmission of a signal or information (e.g., via one or more networks), other features, and/or combinations thereof.

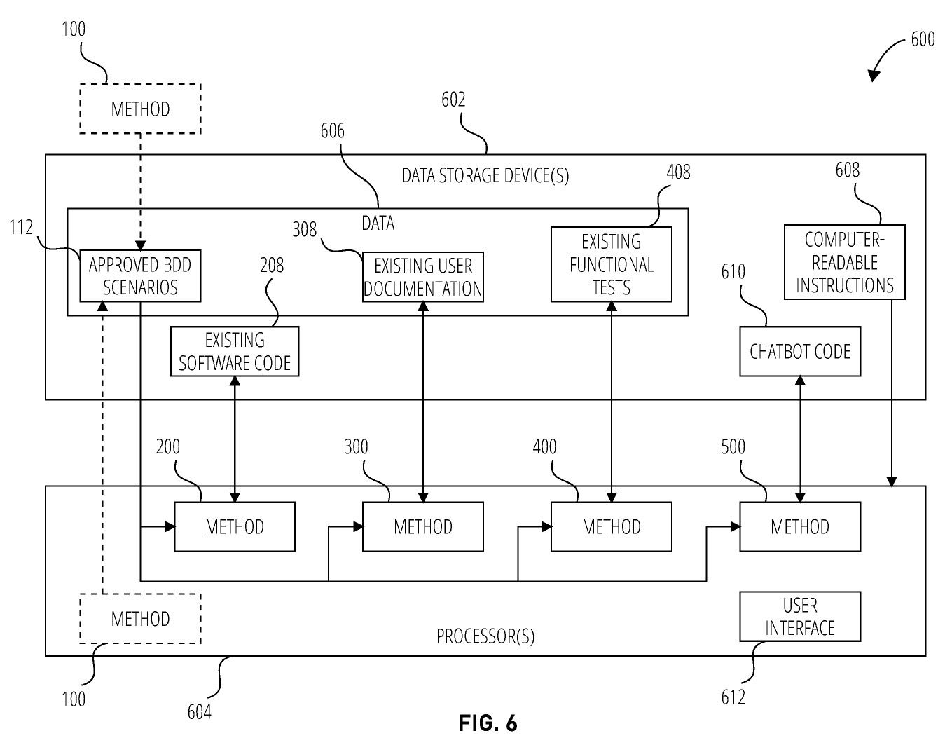

At operation 104, the method 100 includes generating BDD scenarios based on the feature defined at operation 102. In some embodiments, generating the BDD scenarios may be a manual process. In some embodiments, generating the BDD scenarios may including humans writing, in plain human language, the functions that should be performed by the software product. In some embodiments, generating the BDD scenarios may be partially or completely automated. By way of non-limiting example, a computing system may provide a user interface (e.g., a graphical user interface such as the user interface 612 of FIG. 6) configured to guide a user through generation of the BDD scenarios. Also by way of non-limiting example, an AI tool may be trained to automatically generate the BDD scenarios based on the features defined at operation 102.

At decision 106, the method 100 includes reviewing the BDD scenarios generated at operation 104. In some embodiments, reviewing the BDD scenarios may be performed by a human user interacting with a user interface (e.g., a graphical user interface such as the user interface 612 of FIG. 6) of a computing system. By way of non-limiting example, the user interface may be configured to present the BDD scenarios to the user and provide user interface elements for indicating approval and for providing feedback upon disapproval of the BDD scenarios. In some embodiments, reviewing the BDD scenarios may be performed by an AI tool trained to approve the BDD scenarios or provide feedback. By way of non-limiting example, the AI tool may be trained with multiple instances of BDD scenarios being provided and resulting human approvals or provision of feedback.

If the BDD scenarios are not approved at decision 106, feedback for changing the BDD scenarios may be provided (e.g., via a user interface), and the method 100 may proceed to operation 108. At operation 108, the method 100 includes updating the BDD scenarios (e.g., based on the feedback). The updated BDD scenarios are then returned to decision 106, reviewing the BDD scenarios. Responsive to a determination at decision 106 that the BDD scenarios are approved (e.g., with or without having gone through feedback and updating the BDD scenarios at operation 108), the method 100 proceeds to operation 110. At operation 110, the method 100 includes accepting the approved BDD scenarios 112. As a result, the method 100 results in provision of the approved BDD scenarios 112.

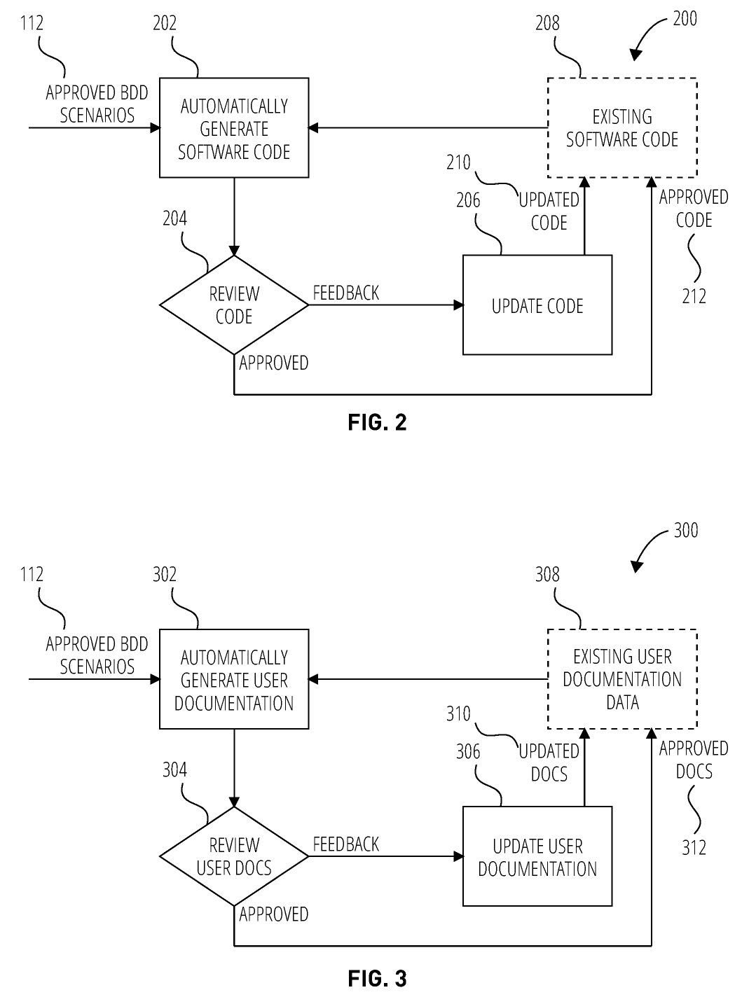

FIG. 2 is a flowchart illustrating a method 200 of automatically generating a software code, according to some embodiments. At operation 202, the method 200 includes automatically generating software code for a software program responsive to approved BDD scenarios 112 (e.g., generated in the method 100 of FIG. 1). In some instances, the approved BDD scenarios 112 correspond to updates to an existing software program. In such instances, an existing software code 208 may be used at operation 202 to automatically generate the software code. By way of non-limiting example, automatically generating the software code may include modifying and/or adding to the existing software code 208 based on the approved BDD scenarios 112. In some instances, the approved BDD scenarios 112 correspond to a new software program. In some such instances, an existing software code 208 may not be used at operation 202 to automatically generate the software code. In other such instances, an existing software code 208 for an existing software program upon which it may be desired to base the new software program may be used at operation 202 to automatically generate the software code.

At decision 204, the method 200 includes reviewing the software code automatically generated at operation 202. In some embodiments, the software code automatically generated at operation 202 may include code at a level of abstraction that it may be understood and reviewed by a human when presented as text on an electronic display. By way of non-limiting example, the software code may be code for any of various software programming languages known in the art such as, for example, Java code, .NET (pronounced “dot net”) code (e.g., C#, F#, VS.NET, etc.), Python code, Swift code, C++ code, Ansi C code, Assembly code, or other software programming language code that is readable by a human reviewer. In some such embodiments, decision 204 (reviewing the software code) may be performed by a human reviewer. By way of non-limiting example, a user interface (e.g., a graphical user interface (GUI)) may be presented on an electronic display. The GUI may enable the human reviewer to view the software code in text form. The GUI may also provide user-selectable options to enable the human reviewer to approve the software code to use the automatically generated software code as approved code 212 or provide feedback for updating the automatically generated software code, if not approved. In some embodiments, decision 204 may be performed automatically. By way of non-limiting example, an AI model (e.g., a language learning model) may be trained to perform the review (e.g., trained from information gathered during performance of example human review of software code). In such examples, if the automatically generated software code from operation 202 is approved at decision 204, the automatically generated code may be provided as approved code 212. If the automatically generated software code is not approved, the AI model may provide feedback for updating the automatically generated software code.

If the automatically generated software code is not approved at decision 204, feedback for updating the automatically generated software code may be provided (automatically or by a human, as discussed above). At operation 206, the method 200 includes updating the software code to produce updated code 210 based on the feedback. Whether updated code 210 or approved code 212 is provided, the updated code 210 or the approved code 212 may be stored as existing software code 208. This existing software code 208 may be acted upon by operation 202, as discussed with reference to operation 202 responsive to subsequent approved BDD scenarios 112 (e.g., for updates to the existing software code 208).

FIG. 3 is a flowchart illustrating a method 300 of automatically generating user documentation, according to some embodiments. At operation 302, the method 300 includes automatically generating user documentation responsive to approved BDD scenarios 112 (e.g., generated in the method 100 of FIG. 1). In some instances, the approved BDD scenarios 112 correspond to updates to an existing software program that already has user documentation associated therewith. In such instances, existing user documentation data 308 corresponding to the existing user documentation may be used at operation 302 to automatically generate the user documentation. By way of non-limiting example, automatically generating the user documentation may include modifying and/or adding to the existing user documentation corresponding to the existing user documentation data 308 based on the approved BDD scenarios 112. In some instances, the approved BDD scenarios 112 correspond to a new software program or an existing software program without existing user documentation. In some such instances, existing user documentation data 308 may not be used at operation 302 to automatically generate the user documentation. In other such instances, existing user documentation data 308 for existing user documentation of another existing software program upon which it may be desired to base the new user documentation may be used at operation 302 to automatically generate the user documentation.

At decision 304, the method 300 includes reviewing the user documentation automatically generated at operation 302. In some embodiments, the user documentation automatically generated at operation 302 may include an electronic user manual, an online help tool, or an application programming interface (API) design tool for the software program. In some embodiments, decision 304 (reviewing an electronic user manual, an online help tool, or an application programming interface (API) design tool for the software program) may be performed by a human reviewer. By way of non-limiting example, a user interface (e.g., a GUI) may be presented on an electronic display. The GUI may enable the human reviewer to view the automatically generated user documentation. The GUI may also provide user-selectable options to enable the human reviewer to approve the automatically generated user documentation to use the automatically generated user documentation as approved user documentation 312 or provide feedback for updating the automatically generated user documentation, if not approved. In some embodiments, decision 304 may be performed automatically. By way of non-limiting example, an AI model (e.g., a language learning model) may be trained to perform the review (e.g., trained from information gathered during performance of example human review of user documentation). In such examples, if the automatically generated user documentation from operation 302 is approved at decision 304, the automatically generated user documentation may be provided as approved user documentation 312. If the automatically generated user documentation is not approved, the AI model may provide feedback for updating the automatically generated user documentation.

If the automatically generated user documentation is not approved at decision 304, feedback for updating the automatically generated user documentation may be provided (e.g., automatically or by a human, as discussed above). At operation 306, the method 300 includes updating the automatically generated user documentation to produce updated user documentation 310 based on the feedback. Whether updated user documentation 310 or approved user documentation 312 is provided, the data corresponding to the updated user documentation 310 or the approved user documentation 312 may be stored as existing user documentation data 308. This existing user documentation data 308 may be acted upon by operation 302, as discussed with reference to operation 302 responsive to subsequent approved BDD scenarios 112.

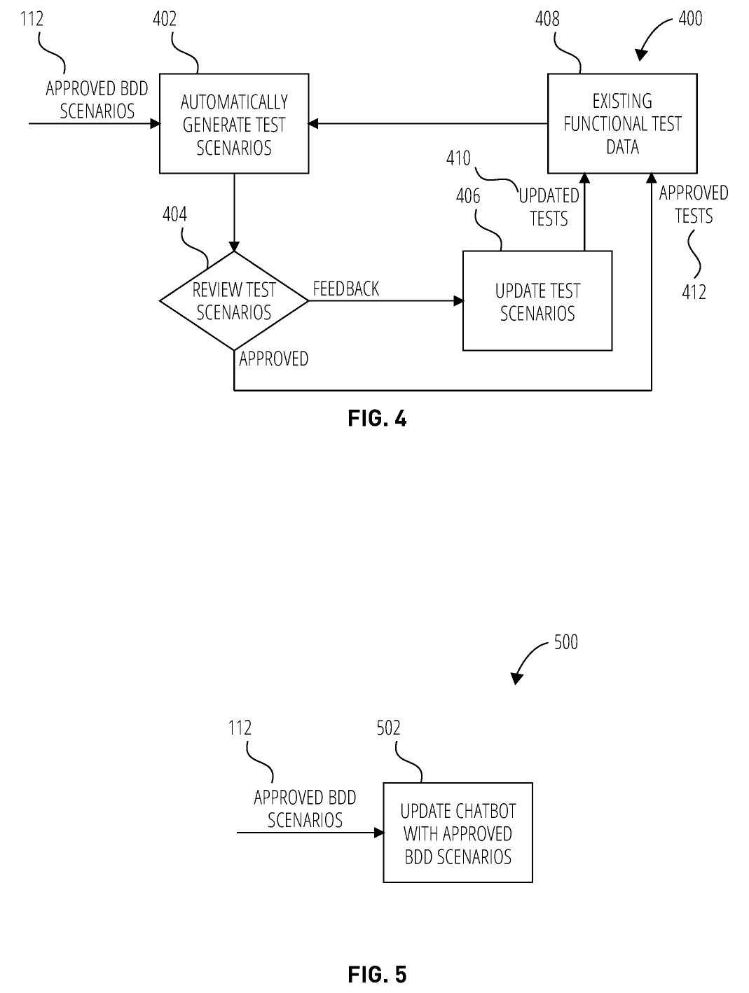

FIG. 4 is a flowchart illustrating a method of automatically generating functional test scenarios, according to some embodiments. At operation 402, the method 400 includes automatically generating test scenarios responsive to approved BDD scenarios 112 (e.g., generated in the method 100 of FIG. 1). In some instances, the approved BDD scenarios 112 correspond to updates to an existing software program that already has test scenarios associated therewith. In such instances, existing functional test data 408 corresponding to the existing test scenarios may be used at operation 402 to automatically generate the test scenarios. By way of non-limiting example, automatically generating the test scenarios may include modifying and/or adding to the existing test scenarios corresponding to the existing functional test data 408 based on the approved BDD scenarios 112. In some instances, the approved BDD scenarios 112 correspond to a new software program or an existing software program without existing test scenarios. In some such instances, existing functional test data 408 may not be used at operation 402 to automatically generate the test scenarios. In other such instances, existing functional test data 408 for existing test scenarios of another existing software program that it may be desired to base the new test scenarios on may be used at operation 402 to automatically generate the test scenarios.

At decision 404, the method 400 includes reviewing the test scenarios automatically generated at operation 402. In some embodiments, the test scenarios automatically generated at operation 402 may include test procedures that are automatically performed. By way of non-limiting example, the test scenarios may include automatically performed test procedures for testing a user interface. Also by way of non-limiting example, the test scenarios may include automatically performed test procedures for testing an application programming interface (API) for interacting with the software program. In some embodiments, decision 404 (reviewing the test scenarios) may be performed by a human reviewer. By way of non-limiting example, a user interface (e.g., a GUI) may be presented on an electronic display. The GUI may enable the human reviewer to view the automatically generated test scenarios. The GUI may also provide user-selectable options to enable the human reviewer to approve the automatically generated test scenarios to use the automatically generated test scenarios as approved test scenarios 412 or provide feedback for updating the automatically generated test scenarios, if not approved. In some embodiments, decision 404 may be performed automatically. By way of non-limiting example, an AI model (e.g., a language learning model) may be trained to perform the review (e.g., trained from information gathered during performance of example human review of test scenarios). In such examples, if the automatically generated test scenarios from operation 402 are approved at decision 404, the automatically generated test scenarios may be provided as approved test scenarios 412. If the automatically generated test scenarios are not approved, the AI model may provide feedback for updating the automatically generated user documentation.

If the automatically generated test scenarios are not approved at decision 404, feedback for updating the automatically generated test scenarios may be provided (e.g., automatically or by a human, as discussed above). At operation 406, the method 400 includes updating the automatically generated test scenarios to produce updated test scenarios 410 based on the feedback. Whether updated test scenarios 410 or approved test scenarios 412 are provided, the data corresponding to the updated test scenarios 410 or the approved test scenarios 412 may be stored as existing functional test data 408. This existing functional test data 408 may be acted upon by operation 402, as discussed with reference to operation 402 responsive to subsequent approved BDD scenarios 112.

FIG. 5 is a flowchart illustrating a method 500 of automatically generating a chatbot, according to some embodiments. A chatbot in the context of an assistant for a user of a software program product may itself be a software program (e.g., powered by AI) that guides the user in interactions with the software program product. In some embodiments, a chatbot may provide instructions for using the software program product and provide answers to questions presented by the user (e.g., in a chatbot textbox field). In some embodiments, a chatbot may have the ability to automate tasks (e.g., repetitive tasks) at a user request. In some embodiments, a chatbot may assist a user in identifying and troubleshooting problems encountered while using the software product. In some embodiments, a chatbot may help a user to personalize options or settings for the software product.

At operation 502, the method 500 includes updating the chatbot with approved BDD scenarios 112 (e.g., from method 100 of FIG. 1). In some embodiments, operation 502 may be performed by an AI model (e.g., a language learning model) trained to generate computer code for the chatbot.

FIG. 6 is a block diagram of a computing system 600, according to some embodiments. The computing system 600 includes one or more processors 604 and one or more data storage devices 602 operably coupled to the one or more processors 604. The one or more data storage devices 602 include, stored thereon, data 606, the existing software code 208 of FIG. 2 for a software program, chatbot code 610 for a chatbot corresponding to the software program, and computer-readable instructions 608. The data 606 includes the approved BDD scenarios 112 of FIG. 1, the existing user documentation data 308 of FIG. 3 corresponding to existing user documentation for the software program, and the existing functional test data 408 of FIG. 4 corresponding to existing functional tests for the software program.

In some embodiments, the computer-readable instructions 608 are configured to instruct the one or more processors 604 to at least partially automate generation of the approved BDD scenarios 112 (e.g., as discussed with reference to the method 100 of FIG. 1). For example, the computer-readable instructions 608 may be configured to instruct the one or more processors 604 to, with interaction from a user of the computing system 600 (e.g., interacting with a user interface 612), define a feature for the software program, generate the one or more BDD scenarios responsive to the defined feature, review the one or more BDD scenarios, and accept the one or more BDD scenarios responsive to a determination that the one or more BDD scenarios are approved. The computer-readable instructions 608 are also configured to instruct the one or more processors 604 to update the one or more BDD scenarios responsive to a determination that the one or more BDD scenarios are not approved.

The computer-readable instructions 608 are configured to instruct the one or more processors 604 to receive, as an input, one or more BDD scenarios (e.g., the approved BDD scenarios 112) corresponding to one or more functions of a software program. The approved BDD scenarios 112 may be used as input to the method 200 of FIG. 2, the method 300 of FIG. 3, the method 400 of FIG. 4, and the method 500 of FIG. 5. For example, the computer-readable instructions 608 may be configured to instruct the one or more processors 604 to automatically generate software code for the software program (e.g., using method 200 of FIG. 2) responsive to the approved BDD scenarios 112, as discussed with reference to FIG. 2, to generate and/or add to the existing software code 208. In some embodiments, the computer-readable instructions 608 implement, when executed by the one or more processors 604, an AI software code generating tool trained to generate the software code responsive to the one or more BDD scenarios. As discussed with reference to FIG. 2, in some embodiments, the computer-readable instructions 608 are configured to instruct the one or more processors 604 to automatically generate updated software code for the software program (e.g., an existing software program) responsive to the one or more approved BDD scenarios 112. As also discussed with reference to FIG. 2, in some embodiments, the computer-readable instructions 608 are configured to instruct the one or more processors 604 to automatically generate new software code for a new software program.

In some embodiments, the computer-readable instructions 608 are also configured to instruct the one or more processors 604 to review the software code (e.g., with intervention from a human user interacting with the user interface 612), store the software code as existing software code 208 on the one or more data storage devices 602 responsive to a determination that the software code is approved, and update the software code based on feedback from a user (e.g., provided via the user interface 612) of the computing system 600 responsive to a determination that the software code is not approved.

The computer-readable instructions 608 are also configured to instruct the one or more processors 604 to automatically generate one or more of user documentation (e.g., using the method 300 of FIG. 3), test scenarios (e.g., using the method 400 of FIG. 4), or a chatbot (e.g., using the method 500 of FIG. 5) responsive to the approved BDD scenarios 112. In some embodiments, the computer-readable instructions 608 are configured to instruct the one or more processors 604 to implement an AI tool trained to automatically generate the one or more of the user documentation, the test scenarios, or the chatbot responsive to the one or more BDD scenarios.

In some embodiments, the computer-readable instructions 608 are configured to instruct the one or more processors 604 to automatically generate user documentation (e.g., the existing user documentation data 308) using the method 300 of FIG. 3 responsive to the approved BDD scenarios 112. By way of non-limiting example, the user documentation may include one or more of an electronic user manual, an online help tool, or an application programming interface (API) design tool for the software program. As discussed with reference to FIG. 3, the computer-readable instructions 608 may be configured to instruct the one or more processors 604 to automatically generate new user documentation for a new software program or update existing user documentation for an existing software program that has been updated (e.g., using the method 200 of FIG. 2).

In some embodiments, the computer-readable instructions 608 are configured to instruct the one or more processors 604 to automatically generate test scenarios (e.g., the existing functional test data 408) using the method 400 of FIG. 4 responsive to the approved BDD scenarios 112. As discussed with reference to FIG. 4, the computer-readable instructions 608 may be configured to instruct the one or more processors 604 to automatically generate new test scenarios for a new software program or update existing test scenarios for an existing software program that has been updated (e.g., using the method 200 of FIG. 2). For example, the computer-readable instructions 608 may be configured to instruct the one or more processors 604 to review the test scenarios, store the test scenarios as existing functional test data 408 on the one or more data storage devices 602 responsive to a determination that the test scenarios are approved, and update the test scenarios with feedback from a user (e.g., interacting with the user interface 612) of the computing system 600 responsive to a determination that the test scenarios are not approved.

In some embodiments, functional tests indicated by the existing functional test data 408 may be run on automatically generated software code before it has been reviewed (e.g., run on automatically generated software code generated at operation 202 of the method 200 of FIG. 2). Accordingly, results of running the functional tests may be part of the review process employed at decision 204 of the method 200 of FIG. 2 to determine whether the software test is meeting the testing needs. In some embodiments, these functional tests may also be performed before the existing user documentation data 308 and the chatbot code 610 are generated so that the user documentation and chatbot may be adjusted to correspond to any adjustments made to the automatically generated software code at operation 206 of the method 200 of FIG. 2. Accordingly, in some embodiments, method 400 may be performed by the one or more processors prior to performing the method 200, the method 300, and the method 500.

In some embodiments, the computer-readable instructions 608 are configured to instruct the one or more processors 604 to automatically generate a chatbot responsive to the approved BDD scenarios 112 to automatically generate and/or update the chatbot code 610 (e.g., using the method 500 of FIG. 5). In some embodiments, the computer-readable instructions 608 implement, when executed by the one or more processors 604, an AI tool trained to generate the chatbot code 610 responsive to the approved BDD scenarios 112. As discussed with reference to FIG. 5, in some embodiments, the computer-readable instructions 608 are configured to instruct the one or more processors 604 to automatically generate an updated chatbot for an existing software program and/or automatically generate a new chatbot for a new software program.

The computer-readable instructions 608 are also configured to instruct the one or more processors 604 to automatically generate one or more of user documentation (e.g., using the method 300 of FIG. 3), test scenarios (e.g., using the method 400 of FIG. 4), or a chatbot (e.g., using the method 500 of FIG. 5) responsive to the one or more BDD scenarios.

Since the existing software code 208, the existing user documentation data 308, the existing functional test data 408, and the chatbot code 610 are generated based on the same approved BDD scenarios 112, the existing user documentation data 308, the existing functional test data 408, and the chatbot code 610 will be updated to fit the functionality of the software program corresponding to the existing software code 208. Accordingly, by providing the approved BDD scenarios 112, software code for a new or updated software program may be automatically generated, along with corresponding user documentation, test scenarios, and a chatbot.

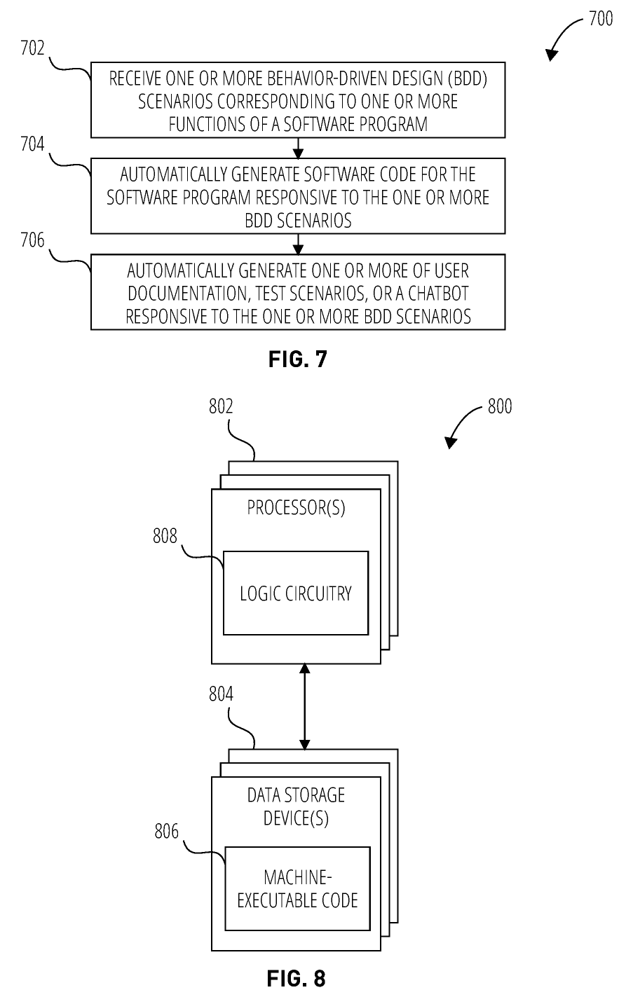

FIG. 7 is a flowchart illustrating a method 700 of generating software code and supplemental products, according to some embodiments. At operation 702, the method 700 includes receiving one or more BDD scenarios corresponding to one or more functions of a software program. At operation 704, the method 700 includes automatically generating software code for the software program responsive to the one or more BDD scenarios. In some embodiments, automatically generating the software code for the software program includes generating an updated software code for an existing software program. In some embodiments, automatically generating the software code for the software program includes generating a new software code for a new software program.

At operation 706, the method 700 includes automatically generating one or more of user documentation, test scenarios, or a chatbot responsive to the one or more BDD scenarios. In some embodiments, automatically generating the one or more of the user documentation, the test scenarios, or the chatbot responsive to the one or more BDD scenarios includes automatically generating one or more of an electronic user manual, an online help tool, or an application program interface (API) design tool for the software program. In some embodiments, automatically generating the one or more of the user documentation, the test scenarios, or the chatbot responsive to the one or more BDD scenarios includes automatically generating the test scenarios including user interface test scenarios. In some embodiments, automatically generating the one or more of the user documentation, the test scenarios, or the chatbot responsive to the one or more BDD scenarios includes automatically generating the test scenarios including API test scenarios.

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 8 illustrates non-limiting examples of implementations of functional elements disclosed herein. In some embodiments, some or all portions of the functional elements disclosed herein may be performed by hardware specially configured for carrying out the functional elements.

FIG. 8 is a block diagram of circuitry 800 that, in some embodiments, may be used to implement various functions, operations, acts, processes, and/or methods disclosed herein. The circuitry 800 includes one or more processors 802 (sometimes referred to herein as “processors 802”) operably coupled to one or more data storage devices (sometimes referred to herein as “storage 804”). The storage 804 includes machine-executable code 806 stored thereon and the processors 802 include logic circuitry 808. The machine-executable code 806 includes information describing functional elements that may be implemented by (e.g., performed by) the logic circuitry 808. The logic circuitry 808 is adapted to implement (e.g., perform) the functional elements described by the machine-executable code 806. The circuitry 800, when executing the functional elements described by the machine-executable code 806, should be considered as special purpose hardware configured for carrying out functional elements disclosed herein. In some embodiments, the processors 802 may be configured to perform the functional elements described by the machine-executable code 806 sequentially, concurrently (e.g., on one or more different hardware platforms), or in one or more parallel process streams.

When implemented by logic circuitry 808 of the processors 802, the machine-executable code 806 is configured to adapt the processors 802 to perform operations of embodiments disclosed herein. For example, the machine-executable code 806 may be configured to adapt the processors 802 to perform at least a portion or a totality of the method 100 of FIG. 1, the method 200 of FIG. 2, the method 300 of FIG. 3, the method 400 of FIG. 4, the method 500 of FIG. 5, and/or the method 700 of FIG. 7. As another example, the machine-executable code 806 may be configured to adapt the processors 802 to perform at least a portion or a totality of the operations discussed for the computing system 600 of FIG. 6.

The processors 802 may include a general-purpose processor, a special purpose processor, a central processing unit (CPU), a microcontroller, a programmable logic controller (PLC), a digital signal processor (DSP), an application specific integrated circuit (ASIC), a field programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine-executable code 806 (e.g., software code, firmware code, hardware descriptions) related to embodiments of the present disclosure. It is noted that a general-purpose processor (may also be referred to herein as a host processor or simply a host) may be a microprocessor, but in the alternative, the processors 802 may include any conventional processor, controller, microcontroller, or state machine. The processors 802 may also be implemented as a combination of computing devices, such as a combination of a DSP and a microprocessor, a plurality of microprocessors, one or more microprocessors in conjunction with a DSP core, or any other such configuration.

In some embodiments the storage 804 includes volatile data storage (e.g., random-access memory (RAM)) and/or non-volatile data storage (e.g., Flash memory, a hard disc drive, a solid state drive, erasable programmable read-only memory (EPROM), etc.). In some embodiments the processors 802 and the storage 804 may be implemented into a single device (e.g., a semiconductor device product, a system on chip (SOC), etc.). In some embodiments, the processors 802 and the storage 804 may be implemented into separate devices.

In some embodiments, the machine-executable code 806 may include computer-readable instructions (e.g., software code, firmware code). By way of non-limiting example, the computer-readable instructions may be stored by the storage 804, accessed directly by the processors 802, and executed by the processors 802 using at least the logic circuitry 808. Also by way of non-limiting example, the computer-readable instructions may be stored on the storage 804, transferred to a memory device (not shown) for execution, and executed by the processors 802 using at least the logic circuitry 808. Accordingly, in some embodiments, the logic circuitry 808 includes electrically configurable logic circuitry 808.

In some embodiments, the machine-executable code 806 may describe hardware (e.g., circuitry 800) to be implemented in the logic circuitry 808 to perform the functional elements. This hardware may be described at any of a variety of levels of abstraction, from low-level transistor layouts to high-level description languages. At a high-level of abstraction, a hardware description language (HDL) such as an IEEE Standard HDL may be used. By way of non-limiting examples, VERILOG^{TM}, SYSTEMVERILOG^{TM} or very large scale integration (VLSI) hardware description language (VHDL^{TM}) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, etc.) of the logic circuitry 808 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments, the machine-executable code 806 may include an HDL, an RTL, a GL description, a mask level description, other hardware description, or any combination thereof.

In embodiments where the machine-executable code 806 includes a hardware description (at any level of abstraction), a system (not shown, but including the storage 804) may be configured to implement the hardware description described by the machine-executable code 806. By way of non-limiting example, the processors 802 may include a programmable logic device (e.g., an FPGA or a PLC) and the logic circuitry 808 may be electrically controlled to implement circuitry 800 corresponding to the hardware description into the logic circuitry 808. Also by way of non-limiting example, the logic circuitry 808 may include hard-wired logic manufactured by a manufacturing system (not shown, but including the storage 804) according to the hardware description of the machine-executable code 806.

Regardless of whether the machine-executable code 806 includes computer-readable instructions or a hardware description, the logic circuitry 808 is adapted to perform the functional elements described by the machine-executable code 806 when implementing the functional elements of the machine-executable code 806. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general-purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general-purpose hardware), specific hardware implementations or a combination of software and specific hardware implementations are also possible and contemplated.

As used in the present disclosure, the term "combination" with reference to a plurality of elements may include a combination of all the elements or any of various different sub-combinations of some of the elements. For example, the phrase "A, B, C, D, or combinations thereof" may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of "two recitations," without other modifiers, means at least two recitations, or two or more recitations). Furthermore, in those instances where a convention analogous to “at least one of A, B, and C, etc.” or “one or more of A, B, and C, etc.” is used, in general, such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A computing system, comprising:
one or more processors; and
one or more data storage devices including computer-readable instructions stored thereon, the computer-readable instructions configured to instruct the one or more processors to:
receive, as input, one or more behavior-driven design (BDD) scenarios corresponding to one or more functions of a software program;
automatically generate software code for the software program responsive to the one or more BDD scenarios; and
automatically generate one or more of user documentation, test scenarios, or a chatbot for the software program responsive to the one or more BDD scenarios.

2. The computing system of claim 1, wherein the computer-readable instructions implement an artificial intelligence (AI) software code generating tool trained to generate the software code responsive to the one or more BDD scenarios.

3. The computing system of claim 1, wherein the computer-readable instructions implement an artificial intelligence (AI) tool trained to automatically generate the one or more of the user documentation, the test scenarios, or the chatbot responsive to the one or more BDD scenarios.

4. The computing system of claim 1, wherein the computer-readable instructions are also configured to instruct the one or more processors to at least partially automate generation of the BDD scenarios, the computer-readable instructions configured to instruct the one or more processors to, with interaction from a user of the computing system:
define a feature for the software program;
generate the one or more BDD scenarios responsive to the defined feature;
review the one or more BDD scenarios; and
accept the one or more BDD scenarios responsive to a determination that the one or more BDD scenarios are approved.

5. The computing system of claim 4, wherein the computer-readable instructions are also configured to instruct the one or more processors to update the one or more BDD scenarios responsive to a determination that the one or more BDD scenarios are not approved.

6. The computing system of claim 1, wherein the computer-readable instructions are also configured to instruct the one or more processors to:
review the software code;
store the software code as existing software code on the one or more data storage devices responsive to a determination that the software code is approved; and
update the software code based on feedback from a user of the computing system responsive to a determination that the software code is not approved.

7. The computing system of claim 1, wherein the computer-readable instructions are also configured to instruct the one or more processors to:
review the test scenarios;
store the test scenarios as existing test scenarios on the one or more data storage devices responsive to a determination that the test scenarios are approved; and
update the test scenarios with feedback from a user of the computing system responsive to a determination that the test scenarios are not approved.

8. The computing system of claim 1, wherein the user documentation includes one or more of an electronic user manual, an online help tool, or an application programming interface (API) design tool for the software program.

9. A method of automatically generating software code and supplemental products, the method comprising:
receiving one or more behavior-driven design (BDD) scenarios corresponding to one or more functions of a software program;
automatically generating software code for the software program responsive to the one or more BDD scenarios; and
automatically generating one or more of user documentation, test scenarios, or a chatbot responsive to the one or more BDD scenarios.

10. The method of claim 9, further comprising automatically generating the one or more BDD scenarios.

11. The method of claim 9, wherein automatically generating the software code for the software program comprises generating an updated software code for an existing software program.

12. The method of claim 9, wherein automatically generating the software code for the software program comprises generating a new software code for a new software program.

13. The method of claim 9, wherein automatically generating the one or more of the user documentation, the test scenarios, or the chatbot responsive to the one or more BDD scenarios includes automatically generating one or more of an electronic user manual, an online help tool, or an application programming interface (API) design tool for the software program.

14. The method of claim 9, wherein automatically generating the one or more of the user documentation, the test scenarios, or the chatbot responsive to the one or more BDD scenarios includes automatically generating the test scenarios comprising user interface test scenarios.

15. The method of claim 9, wherein automatically generating the one or more of the user documentation, the test scenarios, or the chatbot responsive to the one or more BDD scenarios includes automatically generating the test scenarios comprising application program interface (API) test scenarios.

16. A computing system, comprising:
one or more processors; and
one or more data storage devices operably coupled to the one or more processors, the one or more data storage devices including, stored thereon:
existing code for a software program;
existing user documentation data corresponding to existing user documentation for the software program;
existing functional test data corresponding to existing functional tests for the software program;
chatbot code for a chatbot corresponding to the software program; and
computer-readable instructions configured to instruct the one or more processors to:
automatically generate updated software code for the software program responsive to one or more behavior-driven design (BDD) scenarios; and
automatically generate one or more of new user documentation data, new functional test data, or new chatbot code responsive to the one or more BDD scenarios.

17. The computing system of claim 16, wherein the computer-readable instructions are configured to instruct the one or more processors to provide a user interface to enable a human user to review automatically generated software code and one or more of automatically generated user documentation, automatically generated functional tests, or an automatically generated chatbot.

18. The computing system of claim 16, wherein the computer-readable instructions are configured to instruct the one or more processors to provide a user interface configured to guide a user through generation of the one or more BDD scenarios.

19. The computing system of claim 16, wherein the computer-readable instructions are configured to instruct the one or more processors to automatically generate the new user documentation data before a review of the updated software code.

20. The computing system of claim 19, wherein the computer-readable instructions are configured to instruct the one or more processors to make the new user documentation data available for use in reviewing the updated software code.
